(19) United States
(12) Patent Application Publication
(10) Pub. No.: US 2007/0040151 A1
(43) Pub. Date: Feb. 22, 2007

(54) Two-component initiator system (amine-free) with very good storage stability and particular suitability for acid systems

(75) Inventors: Andreas Utterodt, Neu Anspach (DE); Heike Hennen, Hurth (DE)

Correspondence Address: William C. Gerstenzang;Norris, McLaughlin & Marcus P.A., 18th Floor, 875 Third Avenue, New York, NY, 10022, US

(73) Assignee: HERAEUS KULZER GMBH, Hanau (DE)

(21) Appl. No.: 11/483,488

(22) Filed: Jul. 10, 2006

(30) Foreign Application Priority Data
Aug. 19, 2005 (DE) 10 2005 039 590.2

(51) Int. Cl. C09K 3/00

(52) U.S. Cl. 252/182.13; 523/116

(57) ABSTRACT

A two-component initiator system having accelerators for curing polymerizable materials comprising the following components: (a) a hydroperoxide compound containing one or more hydroperoxide groups that are bound to a tertiary carbon; (b) a thiourea derivative; and (c) as accelerator, a copper compound which is soluble in the preparation is preferably free of amine and is particularly suited for polymerizable dental compositions.

The invention relates to a novel, two-component initiator system having accelerators for curing polymerizable materials.

### BACKGROUND OF THE INVENTION

Two-component initiator systems for curing polymerizable materials are known:
1. Benzoyl peroxide/tertiary aromatic amine: Of the peroxides that can be initiated using amines, dibenzoyl peroxide exhibits the highest thermal stability. However, continuous heating of the preparations results in the rapid onset of spontaneous curing. In addition, the slow oxidation of the amines results in yellowish-brown discoloration and impairs the appearance, which is disadvantageous for dental applications. In an acidic environment, which is necessary in adhesives, the amine is immediately protonated in an acid/base reaction and is thereby deactivated. The two-component system cannot be used under such conditions.
2. Barbituric acid derivatives: Use of the barbituric acid initiator system is favored in dental applications because strong discoloration does not occur afterwards. The second component contains copper and chloride ions which catalyze decomposition of the barbituric acid. Since the system contains no amine, it can also be used under acidic conditions. On account of the low thermal stability the products must always be stored at cool temperatures. The initiator component cannot contain any reactive, crosslinking ingredients, or otherwise spontaneous polymerization occurs.
3. Cumene hydroperoxide/acetylthiourea: An endodontic sealant system has been described in US 2003/0134933 (Pentron). This system contains fairly large quantities (1-10%) of cumene hydroperoxide and acetylthiourea, and possibly traces back to the description of an adhesive in JP 58219281A (Mitsubishi). Very high thermal stability compared to a conventional system was described. However, readjustment of the composition showed unsatisfactorily slow curing kinetics in the lower concentration range. At the lower limit in the description (1% in each case) polymerization completely failed.
4. Cumene hydroperoxide/accelerators: An adhesive according to DE 195 01 933 (Henkel) contains a hydroperoxide as initiator, and as accelerator contains one of the following compounds: sulfimides, hydrazine derivatives, tertiary amines, and salts or complexes of copper. Drying agents may also be contained for accelerating the crosslinking. High reactivity is achieved in individual compositions, but these are strongly colored by the metal salts, display strong yellowing, or exhibit inadequate storage stability.
5. Peroxide/metal compound: A polymerizable composition containing a thermally stable peroxide is described in DE 696 21 500 (Dentsply). In addition to cumene hydroperoxide, the polymerizable system may also contain a metal compound in the form of a thiourea complex. Copper compounds, among others, are described as metal compounds. An acid and an amine must also be contained therein. A powder-liquid system was specifically described in the claims. Although the initiator system as described is apparently functional in an acid-containing environment, the amine contained therein can result in the typical discoloration of such products.
6. EP 1 479 364 A1 describes amine-free two-component dental compositions comprising a thiourea-hydroperoxide initiator system.

Accordingly, the object is to develop an improved system which has short inhibition times and low content of the initiator components, preferably containing no amine in order to prevent discoloration, and which ensures to the greatest extent possible the functionality under acidic conditions.

### SUMMARY OF THE INVENTION

Surprisingly, it has been found that catalytic amounts of copper compounds markedly improve the initiator effect of such thiourea-hydroperoxide initiator systems. The object is therefore achieved by an initiator system according to claim 1, and by compositions containing same according to claim 2. The subclaims state advantageous embodiments.

### DETAILED DESCRIPTION

The combination of the redox partners cumene hydroperoxide and acetylthiourea in the presence of copper compounds has proven to be particularly suitable. The components, individually and in reactive monomers, can be stored for several months even at high temperatures around 50° C. The low proportions of copper (<0.1%) accelerate the initial redox process so greatly that a concentration of 1% or less of the redox partners is sufficient. Since amine is not contained therein, no subsequent color change has been observed. The pale yellow-green appearance of the polymer depends on the copper concentration, and remains unchanged. The functionality of the two-component system was not adversely affected by the presence of acids.

The system has the following advantages:
a) The composition represents a two-component initiator system having very high storage stability. The composition does not exhibit subsequent discoloration and is not impaired by acids. The inhibition time may be adjusted over a very wide range by varying the copper content. Numerous tests have been carried out for various combinations, and the respective inhibition times determined. The concentrations of cumene hydroperoxide, acetylthiourea, and copper salt were varied. Two copper salts (acetylacetonate, naphthenate) were tested which showed no apparent differences in reactivity. The inhibition times were determined under acidic conditions by combination with phosphoric acid ester (2%, 5%), 4-META (15%), and acrylic acid (5%). The storage stabilities of all preparations were tracked at 50° C. over a period of up to 3 months. The effect of the copper content on the coloration of the polymer was determined, and the color stability was monitored.
b) The initiator system is universally applicable for all radically polymerizable systems. The very good storage stability and the low tendency toward discoloration are particularly advantageous for the production of medical or dental synthetic materials. The possibility of combining with acidic components may open up new fields of application (adhesives, self-etching preparations).
c) Compared to the conventional two-component system composed of dibenzoyl peroxide and a tertiary aromatic amine, the inventive system is characterized by markedly better storage stability, may also be processed under acidic conditions, and exhibits improved color stability.
d) The composition constitutes a redox system, and in the activated state contains a hydroperoxide as oxidation agent and a thiourea derivative as reducing agent. An initiator system as described is known from patents JP 58219281, US 2003/0134933, US 2003/0166740, and EP 1 479364.

It was unexpectedly found that the addition of soluble copper compounds results in an accelerator with greatly improved initiation. Addition of acids does not adversely affect the system, and can even lead to a further increase in the initiation activity. Through the addition of copper compounds it is possible to reduce both the concentration of the activating hydroperoxide component and the proportion of the thiourea derivative while still achieving a suitable inhibition time (processing time). The storage stability of the two-component initiator system is not adversely changed by a proportion of the copper compound, as shown in tests. The pale, yellowish intrinsic color of the polymers consistently remains unchanged.

The composition of the two-component initiator system according to the invention contains an organic hydroperoxide in one component, whereby the compound may also contain more than one hydroperoxide group. In addition to other compounds, t-butylhydroperoxide, t-amylhydroperoxide, benzene hydroperoxide, pinane hydroperoxide, 1,1,3,3-tetramethylbutylhydroperoxide, 5-phenyl-4-pentenylhydroperoxide, and p-diisopropylbenzene hydroperoxide are suitable, with isopropylbenzene hydroperoxide being particularly suitable.

A second component contains a thiourea derivative and at least one copper compound. The following are examples of such thiourea derivatives:
1-(1,1-Dioxotetrahydrothiophene-3-yl)-1-methyl-3-phenyl-thiourea
1-(1,2-Diphenylethyl)-3-(2,4-xylyl)-2-thiourea
1-(1,2-Diphenylethyl)-3-(4-ethoxyphenyl)-2-thiourea
1-(1,2-Diphenylethyl)-3-(ortho-tolyl)-2-thiourea
1-(1,2-Diphenylethyl)-3-phenyl-2-thiourea
1,1′-(3,3′-Dimethylbiphenyl-4,4′-diyl)bis(3-(2-methylpropyl)-2-thiourea)
1,1,3-Triphenyl-2-thiourea
1,1′-(4,5-Dimethyl-1,2-phenylene)bis(3-phenyl-2-thiourea)
1-(1,5-Dime[thyl]-3-oxo-2-ph[enyl]-2,3-dihydro-1H-pyrazole-4-yl)-3-(2-methylallyl)thiourea
1-(1,5-Dime[thyl]-3-oxo-2-ph[enyl]-2,3-dihydro-1H-pyrazole-4-yl)-3-(3-trif[luoro]me[thyl]ph[enyl])thiourea
1-(1,5-Dimethyl-3-oxo-2-phenyl-2,3-dihydro-1H-pyrazol-4-yl)-3-phenylthiourea
1,1-Bis-(2-hydroxyethyl)-3-phenylthiourea
1,1-Diallyl-3-(3-chlorobenzo(b)thiophene-2-carbonyl)thiourea
1,1-Diallyl-3-(4-nitrophenyl)-2-thiourea
1,1-Diallyl-3-phenyl-2-thiourea
1,1-Dibenzyl-3-(2,4-dichlorobenzoyl)thiourea
1,1-Dibenzyl-3-(2-(trifluoromethyl)phenyl)-2-thiourea
1,1-Dibenzyl-3-phenyl-2-thiourea
1,1-Dibutyl-3-phenyl-2-thiourea
1,1-Diethyl-3-phenyl-2-thiourea
1,1-Diisobutyl-3-phenyl-2-thiourea
1,1-Diisopropyl-3-phenyl-2-thiourea
1,1-Dimethyl-3-(2,6-xylyl)-2-thiourea
1,1-Dimethyl-3-(2-methoxyphenyl)-2-thiourea
1,1-Dimethyl-3-(3,4-xylyl)-2-thiourea
1,1-Dimethyl-3-(4-ethoxyphenyl)-2-thiourea
1,1-Dimethyl-3-(4-methoxyphenyl)-2-thiourea
1,1-Dimethyl-3-(alpha-(methylimino)benzyl)-2-thiourea
1,1-Dimethyl-3-(meta-tolyl)-2-thiourea
1,1-Dimethyl-3-(ortho-tolyl)-2-thiourea
1,1-Dimethyl-3-(para-tolyl)-2-thiourea
1,1-Dimethyl-3-phenyl-2-thiourea
1,1-Dipropyl-3-phenyl-2-thiourea
1-(1-Ethyl-3-piperidinyl)-3-phenyl-2-thiourea
1-(1-Naphthyl)-2-thiourea
1-(1-Naphthyl)-3-(2-phenoxypropionyl)-2-thiourea
1,1-Pentamethylene-3-phenyl-2-thiourea
1-(2,2-Dimethylpropyl)-3-(2-fluorophenyl)thiourea
1-(2-(2-Hydroxyethoxy)ethyl)-3-phenylthiourea
1-(2,4,6-Tribromophenyl)-2-thiourea
1-(2,4-Dichlorobenzoyl)-3-(1-naphthyl)-2-thiourea
1-(2,4-Dichlorobenzoyl)-3-(7-hydroxy-1-naphthyl)-2-thiourea
1-(2,4-Dichlorophenyl)-2-thiourea
1-(2,4-Difluorophenyl)-3-(2-fluorophenyl)-2-thiourea
1-(2,4-Difluorophenyl)-3-(4-phenoxyphenyl)-2-thiourea
1-(2,4-Difluorophenyl)-3-ethyl-2-thiourea
1-(2,5-Dichlorophenyl)-3-(2-phenoxypropionyl)-2-thiourea
1-(2,5-Dichlorophenyl)-3-dodecanoyl-2-thiourea
1-(2,5-Dichlorophenyl)-3-phenyl-2-thiourea
1-(2,5-Dimethoxyphenyl)-3-(3-nitrobenzoyl)-2-thiourea
1-(2,5-Dimethoxyphenyl)-3-dodecanoyl-2-thiourea
1-(2,5-Dimethoxyphenyl)-3-methyl-2-thiourea
1-(2,5-Dimethoxyphenyl)-3-phenyl-2-thiourea
1-(2,5-Dimethoxyphenyl)-3-propyl-2-thiourea
1-(2,5-Dimethylmorpholino)-3-phenyl-2-thiourea
1-(2,6-Diethylphenyl)-3-(4-hydroxyphenyl)-2-thiourea
1-(2,6-Xylyl)-2-thiourea
1-(2-Bromo-4-methylphenyl)-3-phenylthiourea
1-(2-Bromophenyl)-2-thiourea
1-(2-Carboxyphenyl)-3-phenyl-2-thiourea
1-(2-Chloro-4-methoxyphenyl)-3-cyclohexyl-2-thiourea
1-(2-Chloro-4-nitrophenyl)-3-(3,4-dichlorobenzoyl)-2-thiourea
1-(2-Chloro-4-nitrophenyl)-3-ethyl-2-thiourea
1-(2-Chloro-5-nitrophenyl)-3-dodecanoyl-2-thiourea
1-(2-Chlorobenzoyl)-3-(2,4-difluorophenyl)-2-thiourea
1-(2-Chlorobenzoyl)-3-(2,4-dimethoxyphenyl)-2-thiourea
1-(2-Chlorobenzoyl)-3-(2-fluorophenyl)-2-thiourea
1-(2-Chlorobenzoyl)-3-(2-methoxy-5-methylphenyl)-2-thiourea
1-(2-Chlorobenzoyl)-3-(3,4-dichlorophenyl)-2-thiourea
1-(2-Chlorobenzoyl)-3-(3-chlorophenyl)-2-thiourea
1-(2-Chlorobenzoyl)-3-(4-nitrophenyl)-2-thiourea
1-(2-Chlorobenzoyl)-3-(5-chloro-2-methoxyphenyl)-2-thiourea
1-(2-Chlorobenzyl)-3-cyclohexyl-1-methyl-2-thiourea
1-(2-Chlorophenyl)-3-(2,4-dichlorobenzoyl)-2-thiourea
1-(2-Chlorophenyl)-3-dodecanoyl-2-thiourea
1-(2-Chlorophenyl)-3-phenyl-2-thiourea
1-(2-Ethylphenyl)-3-methyl-2-thiourea
1-(2-Fluorobenzoyl)-3-(4-ethoxyphenyl)-2-thiourea
1-(2-Fluorobenzoyl)-3-(4-fluorophenyl)-2-thiourea
1-(2-(Hexadecylthio)phenyl)-2-thiourea
1-(2-Hydroxy-1-phenylethyl)-3-phenylthiourea
1-(2-Hydroxycyclohexyl)-3-phenylthiourea
1-(2-Hydroxyethyl)-3-(2,4-xylyl)-2-thiourea
1-(2-Hydroxyethyl)-3-phenyl-2-thiourea
1-(2-Methoxy-5-methylphenyl)-1-methyl-3-(2-naphthyl)-2-thiourea
1-(2-Methoxyphenyl)-3-(2-methylbenzoyl)thiourea
1-(2-Methoxyphenyl)-2-thiourea
1-(2-Methoxyphenyl)-2-thiourea
1-(2-Methyl-2-morpholine-4-yl-propyl)-3-phenylthiourea
1-(2-Methylallyl)-3-(6-(3-(2-methylallyl)thioureido)pyridine-2-yl)thiourea
1-(2-Methylbenzoyl)-3-p-tolylthiourea
1-(2-Methylbenzoyl)-3-phenylthiourea
1-(2-Methylbenzoyl)-3-pyrimidine-2-yl-thiourea
1-(2-Morpholinoethyl)-3-phenyl-2-thiourea
1-(2-Naphthyl)-3-phenyl-2-thiourea
1-(2-Nitrophenyl)-3-phenyl-2-thiourea
1-(2-Pyridyl)-3-(3,4-xylyl)-2-thiourea
1-(2-Pyridyl)-3-(ortho-tolyl)-2-thiourea
1-(3-(2-Mercaptoethyl)-3H-benzothiazole-2-ylidene)-2-me[thyl]isothiourea, hydriodide
1-(3,4-Dibromophenyl)-3-phenyl-2-thiourea
1-(3,4-Dichlorobenzoyl)-3-(2,4-difluorophenyl)-2-thiourea
1-(3,4-Dichlorobenzoyl)-3-(2-fluorophenyl)-2-thiourea
1-(3,4-Dichlorobenzoyl)-3-(2-thiazolyl)-2-thiourea
1-(3,4-Dichlorobenzoyl)-3-(3,4-dichlorophenyl)-2-thiourea
1-(3,4-Dichlorobenzoyl)-3-(4-ethoxyphenyl)-2-thiourea
1-(3,4-Dichlorobenzoyl)-3-(4-nitrophenyl)-2-thiourea
1-(3,4-Dichlorobenzoyl)-3-(4-sulfamoyl)phenyl-2-thiourea
1-(3,4-Dichlorophenyl)-2-thiourea
1-(3,4-Dichlorophenyl)-3-(3,5-dinitrobenzoyl)-2-thiourea
1-(3,4-Dichlorophenyl)-3-(4-sulfamoylphenyl)-2-thiourea
1-(3,4-Dichlorophenyl)-3-(diphenylmethyl)-2-thiourea
1-(3,4-Dichlorophenyl)-3-phenyl-2-thiourea
1-(3,4-Dimethoxybenzyl)-3-phenylthiourea
1-(3,4-Dimethoxyphenyl)-2-thiourea
1-(3,5-Dichlorobenzyl)-3-phenyl-2-thiourea
1-(3,5-Dichlorophenyl)-2-thiourea
1-(3-Acetylphenyl)-3-allyl-2-thiourea
1-(3-Acetylphenyl)-3-ethyl-2-thiourea
1,3-Bis(2,6-dichlorophenyl)-2-thiourea
1,3-Bis(2-chlorophenyl)-2-thiourea
1,3-Bis(2-fluorophenyl)-2-thiourea
1,3-Bis-(2-methoxyphenyl)-2-thiourea
1,3-Bis(3-acetylphenyl)-2-thiourea
1,3-Bis(3-bromophenyl)-2-thiourea
1,3-Bis(3-cyanophenyl)-2-thiourea
1,3-Bis(3-iodophenyl)-2-thiourea
1,3-Bis(3-methoxyphenyl)-2-thiourea
1,3-Bis(3-nitrophenyl)-2-thiourea
1,3-Bis(3-pyridylmethyl)-2-thiourea
1,3-Bis(4-bromophenyl)-2-thiourea
1,3-Bis(4-chlorophenyl)-2-thiourea
1,3-Bis(4-cyanophenyl)-2-thiourea
1,3-Bis(4-(dimethylamino)phenyl)-2-thiourea
1-(3-Bromophenyl)-3-(2-methylbenzoyl)thiourea
1-(3-Bromophenyl)-3-(naphthalene-1-carbonyl)thiourea
1-(3-Bromobenzoyl)-3-(3-chlorophenyl)-2-thiourea
1-(3-Butoxypropyl)-3-phenyl-2-thiourea
1-(3-Carboxyphenyl)-2-thiourea
1-(3-Chloro-2-methylphenyl)-3-(3,4,5-trimethoxybenzoyl)thiourea
1-(3-Chloro-2-methylphenyl)-3-(4-fluorobenzoyl)thiourea
1-(3-Chlorobenzo(b)thiophene-2-carbonyl)-3-(4-nitrophenyl)thiourea
1-(3-Chlorobenzyl)-3-phenyl-2-thiourea
1-(3-Chlorophenyl)-2-thiourea
1-(3-Chlorophenyl)-3-(2-fluorobenzoyl)-2-thiourea
1-(3-Chlorophenyl)-3-(3,4-dichlorobenzoyl)-2-thiourea
1-(3-Chlorophenyl)-3-dodecanoyl-2-thiourea
1-(3-Chlorophenyl)-3-phenyl-2-thiourea
1,3-Di-o-tolyl-2-thiourea
1,3-Di-o-tolyl-2-thiourea
1,3-Di-p-tolyl-2-thiourea
1,3-Di-tert-butyl-2-thiourea
1,3-Diallyl-2-thiourea
1,3-Dibenzyl-2-thiourea
1-(3-(Dibutylamino)propyl)-3-phenyl-2-thiourea
1,3-Dicyclohexyl-2-thiourea
1,3-Didecyl-2-thiourea
1,3-Didodecyl-2-thiourea
1,3-Difurfuryl-2-thiourea
1,3-Diheptyl-2-thiourea
1,3-Dihexadecyl-2-thiourea
1,3-Dihexyl-2-thiourea
1,3-Diisopropyl-2-thiourea
1,3-Dioctyl-2-thiourea
1,3-Dipropyl-2-thiourea
1,3-Ditetradecyl-2-thiourea
1-(3-Fluorophenyl)-3-(3-nitrobenzoyl)-2-thiourea
1-(3-Fluorophenyl)-3-methyl-2-thiourea
1-(3-Hydroxyphenyl)-3-(4-nitrophenyl)-2-thiourea
1-(3-Hydroxyphenyl)-3-phenyl-2-thiourea
1-(3-Methoxyphenyl)-3-(2-methylbenzoyl)thiourea
1-(3-Methoxyphenyl)-3-(naphthalene-1-carbonyl)thiourea
1-(3-Methoxypropyl)-2-thiourea
1-(3-Nitrophenyl)-3-(3-phenylacryloyl)thiourea
1-(3-Nitrophenyl)-3-phenyl-2-thiourea
1-(3-Phenylpropionyl)-3-(2,3-xylyl)-2-thiourea
1-(3-Pyridyl)-2-thiourea
1-(3-(Trifluoromethyl)phenyl)-2-thiourea
1-(3-Trifluoromethylphenyl)-3-(2,3,4-trimethoxybenzoyl)thiourea
1-(3H-benzothiazole-2-ylidene)-2-benzylisothiourea
1-(4-Acetamidophenyl)-3-(2-butenoyl)-2-thiourea
1-(4-Acetamidophenyl)-3-(2-phenoxyacetyl)-2-thiourea
1-(4-Acetamidophenyl)-3-ethyl-2-thiourea
1-(4-Acetylphenyl)-3-methyl-2-thiourea
1-(4-Bromophenyl)-3-(2,4-dichlorobenzoyl)thiourea
1-(4-Chloro-2,5-dimethoxyphenyl)-3-(4-nitrophenyl)-2-thiourea
1-(4-Chloro-2,5-dimethoxyphenyl)-3-methyl-2-thiourea
1-(4-Chloro-2-methylphenyl)-3-(2-methyl-3-phenylacryloyl)thiourea
1-(4-Chloro-2-methylphenyl)-3-dodecanoyl-2-thiourea
1-(4-Chloro-7-methoxy-2-quinolyl)-3-phenyl-2-thiourea
1-(4-Chlorophenyl)-3-(4-nitrobenzoyl)thiourea
1-(4-Chlorophenyl)-3-(naphthalene-1-carbonyl)thiourea
1-(4-Chlorobenzyl)-1-methyl-3-phenyl-2-thiourea
1-(4-Chlorophenyl)-2-thiourea
1-(4-Chlorophenyl)-3-(2-pyridyl)-2-thiourea
1-(4-Chlorophenyl)-3-(4-diethylamino-ortho-tolyl)-2-thiourea
1-(4-Chlorophenyl)-3-phenyl-2-thiourea
1-(4-Difluoromethoxy-2-formylphenyl)-3-(1,2,2-trimethylpropyl)thiourea
1-(4-Difluoromethoxyphenyl)-3-(1,2,2-trimethylpropyl)thiourea
1-(4-Difluoromethylsulfanylphenyl)-3-(1,2,2-trimethylpropyl)thiourea
1-(4-(Dimethylamino)phenyl)-3-(4-nitrophenyl)-2-thiourea
1-(4-(Dimethylamino)phenyl)-3-dodecanoyl-2-thiourea
1-(4-(Dimethylamino)phenyl)-3-(phenyl)-2-thiourea
1-(4-Ethoxycarbonyl)-3-ethyl-2-thiourea
1-(4-Ethoxyphenyl)-3-(1-naphthylcarbonyl)-2-thiourea
1-(4-Ethoxyphenyl)-3-(2-pyridyl)-2-thiourea
1-(4-Ethoxyphenyl)-3-(3-nitrobenzoyl)-2-thiourea
1-(4-Ethoxyphenyl)-3-ethyl-2-thiourea
1-(4-Ethylphenyl)-3-phenyl-2-thiourea
1-(4-Fluorophenyl)-3-(2,4,6-trimethylphenyl)-2-thiourea
1-(4-Fluorophenyl)-3-(3-nitrobenzoyl)-2-thiourea
1-(4-(Hexadecylsulfonyl)phenyl)-2-thiourea
1-(4-Hydroxyphenyl)-3-propyl-2-thiourea
1-(4-Iodophenyl)-3-(3-phenylpropionyl)-2-thiourea
1-(4-Me[th]o[xy]ph[enyl])-3-((4-me[th]o[xy]phenyl)-(toluene-4-sulfonylmethylimino)methyl)thiourea
1-(4-Methoxybenzyl)-3-phenylthiourea
1-(4-Methoxyphenyl)-3-(4-methylbenzoyl)thiourea
1-(4-Methoxyphenyl)-3-phenylthiourea
1-(4-Methoxyphenyl)-3-(2-pyridyl)-2-thiourea
1-(4-Methoxyphenyl)-3-(2-pyridyl)-2-thiourea
1-(4-Methylbenzyl)-3-phenyl-2-thiourea
1-(4-Nitrobenzoyl)-3-pyridine-2-yl-methylthiourea
1-(4-Nitrophenyl)-2-thiourea
1-(4-Nitrophenyl)-3-(3-(trifluoromethyl)phenyl)-2-thiourea
1-(4-Nitrophenyl)-3-phenyl-2-thiourea
1-(4-Pyridylmethyl)-3-(2,6-xylyl)-2-thiourea
1-(4-tert-Butylphenyl)-2-thiourea
1-(4-Trifluoromethoxyphenyl)-3-(1,2,2-trimethylpropyl)thiourea
1-(4-Trifluoromethylsulfanylphenyl)-3-(1,2,2-trimethylpropyl)thiourea
1-(5-Anilino-1,2,4-thiadiazole-3-yl)-3-phenyl-2-thiourea
1-(5-Bromo-3-methylpyridine-2-yl)-3-phenylthiourea
1-(5-Chloro-2,4-dimethoxyphenyl)-3-(2,4-difluorophenyl)-2-thiourea
1-(5-Chloro-2,4-dimethoxyphenyl)-3-(2,5-dimethoxyphenyl)-2-thiourea
1-(5-Chloro-2,4-dimethoxyphenyl)-3-(2-fluorophenyl)-3-methyl-2-thiourea
1-(5-Chloro-2,4-dimethoxyphenyl)-3-methyl-2-thiourea
1-(5-Chloro-2-methoxyphenyl)-3-(3,4-dichlorobenzoyl)-2-thiourea
1-(5-Chloro-2-methoxyphenyl)-3-phenyl-2-thiourea
1-(5-Hydroxy-1-naphthyl)-3-phenyl-2-thiourea
1-Acetyl-3-phenyl-2-thiourea
1-Allyl-3-(1,2-diphenylethyl)-2-thiourea
1-Allyl-3-(1,5-dimethyl-3-oxo-2-phenyl-2,3-dihydro-1H-pyrazole-4-yl)thiourea
1-Allyl-3-(1-naphthyl)-2-thiourea
1-Allyl-3-(1-naphthylmethyl)-2-thiourea
1-Allyl-3-(2-(1-hydroxyethyl)phenyl)-2-thiourea
1-Allyl-3-(2-ethoxyphenyl)-2-thiourea
1-Allyl-3-(3-chloro-2-methylphenyl)-2-thiourea
1-Allyl-3-(3-hydroxyphenyl)-2-thiourea
1-Allyl-3-(4-chlorobenzyl)-2-thiourea
1-Allyl-3-(4-chlorophenyl)-2-thiourea
1-Allyl-3-(4-hydroxyphenyl)-2-thiourea
1-Allyl-3-(diphenylmethyl)-2-thiourea
1-Allyl-3-morpholine-4-yl-thiourea
1-Allyl-3-o-tolylthiourea
1-Allyl-3-octadecyl-2-thiourea
1-Allyl-3-phenyl-2-thiourea
1-(alpha-Methylbenzyl)-3-(4-pyridylmethyl)-2-thiourea
1-(alpha-Methylbenzyl)-3-phenylthiourea
1-Amidino-2-thiourea oxalate
1-Amidino-3-(4-bromophenyl)-2-thiourea
1-Amidino-3-benzoyl-2-thiourea
1-Amidino-3-methyl-2-thiourea p-toluenesulfonate
1-Amidino-3-(p-tolyl)-2-thiourea
1-Amidino-3-propyl-2-thiourea
1-Amidino-3-propyl-2-thiourea p-toluenesulfonate
1-Benzothiazole-2-yl-3-phenylthiourea
1-Benzoyl-3-(1,5-dimethyl-3-oxo-2-phenyl-2,3-dihydro-1H-pyrazole-4-yl)thiourea
1-Benzoyl-3-(1,5-dimethyl-3-oxo-2-phenylpyrazolidine-4-yl)thiourea
1-Benzoyl-3-(2,4,6-trimethylphenyl)thiourea
1-Benzoyl-3-(2,6-dichlorophenyl)-2-thiourea
1-Benzoyl-3-(2-chlorobenzyl)thiourea
1-Benzoyl-3-(2-chlorophenyl)-2-thiourea
1-Benzoyl-3-(3,4-dimethoxyphenethyl)-2-thiourea
1-Benzoyl-3-(4-dimethylaminophenyl)thiourea
1-Benzoyl-3-(4-methoxy-2-nitrophenyl)-2-thiourea
1-Benzoyl-3-(4-morpholine-4-yl-phenyl)thiourea
1-Benzoyl-3-(4-nitrophenyl)-2-thiourea
1-Benzoyl-3-(4-oxothiazolidine-2-ylidene)thiourea
1-Benzoyl-3-(alpha,alpha,alpha-trifluoro-ortho-tolyl)-2-thiourea
1-Benzoyl-3-p-tolylthiourea
1-Benzoyl-3-phenyl-2-thiourea
1-Benzoyl-3-pyridine-2-yl-methylthiourea
1-(Benzoylamidino)-2-thiourea
1-Benzyl-1-butyl-3-phenyl-2-thiourea
1-Benzyl-1-ethyl-3-phenyl-2-thiourea
1-Benzyl-2-thiourea
1-Benzyl-3-(2-methylbenzoyl)thiourea
1-Benzyl-3-(2-phenoxypropionyl)-2-thiourea
1-Benzyl-3-(4-chloro-2-(trifluoromethyl)phenyl)-2-thiourea
1-Benzyl-3-(4-fluoro-3-nitrophenyl)-2-thiourea
1-Benzyl-3-(4-trifluoromethylsulfanylphenyl)thiourea
1-Benzyl-3-cinnamoyl-2-thiourea
1-Benzyl-3-cyclohexyl-1-ethyl-2-thiourea
1-Benzyl-3-furfuryl-2-thiourea
1-Benzyl-3-methyl-2-thiourea
1-Benzyl-3-phenyl-2-thiourea
1-Butyl-2-thiourea
1-Butyl-3-(2-pyridyl)-2-thiourea
1-Butyl-3-(4-isopropylphenyl)-2-thiourea
1-Butyl-3-phenyl-2-thiourea
1-Cinnamoyl-3-(4-ethoxyphenyl)-2-thiourea
1-Cinnamoyl-3-(4-hydroxyphenyl)-2-thiourea
1-Cyano-3-methylisothiourea, sodium salt
1-Cyclododecyl-3-(4-ethoxyphenyl)-2-thiourea
1-Cyclohexyl-1-methyl-3-phenyl-2-thiourea
1-Cyclohexyl-3-(2-ethoxyphenyl)-2-thiourea
1-Cyclohexyl-3-(2-morpholinoethyl)-2-thiourea
1-Cyclohexyl-3-(4-ethoxyphenyl)-2-thiourea
1-Cyclohexyl-3-phenyl-2-thiourea
1-Cyclopentyl-3-phenyl-2-thiourea
1-Diphenylmethyl-3-(2-phenethyl)-2-thiourea
1-Dodecanoyl-2-thiourea
1-Dodecanoyl-3-(1-naphthyl)-2-thiourea
1-Dodecanoyl-3-(2-ethoxyphenyl)-2-thiourea
1-Dodecanoyl-3-(2-methoxy-4-nitrophenyl)-2-thiourea
1-Dodecanoyl-3-(2-methyl-4-nitrophenyl)-2-thiourea
1-Dodecanoyl-3-(2-methyl-5-nitrophenyl)-2-thiourea
1-Dodecanoyl-3-(2-naphthyl)-2-thiourea
1-Dodecanoyl-3-(2-pyrimidinyl)-2-thiourea
1-Dodecanoyl-3-(2-(trifluoromethyl)phenyl)-2-thiourea
1-Dodecanoyl-3-(4-methoxyphenyl)-2-thiourea
1-Dodecanoyl-3-(4-(N-methylacetamido)phenyl)-2-thiourea
1-Dodecyl-3-phenyl-2-thiourea
1-Ethyl-3-(2-fluorophenyl)-2-thiourea
1-Ethyl-3-(2-methoxy-5-methylphenyl)-2-thiourea
1-Ethyl-3-(3,4-xylyl)-2-thiourea
1-Ethyl-3-(4-nitrophenyl)-2-thiourea
1-Ethyl-3-(m-tolyl)-2-thiourea
1-Ethyl-3-(p-tolyl)-2-thiourea
1-Ethyl-3-phenyl-2-thiourea
1-(Furan-2-carbonyl)-3-(2-trifluoromethylphenyl)thiourea
1-(Furan-2-carbonyl)-3-(5-methylpyridine-2-yl)thiourea
1-(Furan-2-carbonyl)-3-furan-2-yl-methylthiourea
1-Furan-2-yl-methyl-3-(2-methylbenzoyl)thiourea
1-Furan-2-yl-methyl-3-(4-(1,1,2,2,3,3,3-heptafluoropropylsulfanyl)-ph[enyl])thiourea
1-Furan-2-yl-methyl-3-(4-nitrobenzoyl)thiourea
1-Furfuryl-3-(1-naphthyl)-2-thiourea
1-Furfuryl-3-phenyl-2-thiourea
1-Hexadecanoyl-2-thiourea
1-Hexadecyl-3-phenyl-2-thiourea
1-(Hexamethyleneimino)-3-(3-(trifluoromethyl)phenyl)-2-thiourea
1-Isobutyl-3-phenyl-2-thiourea
1-Isopropyl-3-(1-naphthyl)-2-thiourea
1-Isopropyl-3-(3-(trifluoromethyl)phenyl)-2-thiourea
1-(Isopropyl)-3-(4-methyl-3-nitrophenyl)-2-thiourea
1-Isopropyl-3-phenyl-2-thiourea
1-Methallyl-3-methyl-2-thiourea
1-Methyl-1-(4-octyloxyphenyl)-2-thiourea
1-Methyl-3-(2,4,5-trichlorophenyl)-2-thiourea
1-Methyl-3-(2,6-xylyl)-2-thiourea
1-Methyl-3-phenyl-2-thiourea
1-Methyl-3-propyl-2-thiourea
1-(Naphthalene-1-carbonyl)-3-m-tolylthiourea
1-(Naphthalene-1-carbonyl)-3-phenylthiourea
1-(Naphthalene-2-carbonyl)-3-(3-nitrophenyl)thiourea
1-(Naphthalene-2-carbonyl)-3-p-tolylthiourea
1-Octadecyl-3-phenyl-2-thiourea
1-Phenethyl-3-phenyl-2-thiourea
1-Phenyl-3-(1,2,4)triazole-4-yl-thiourea
1-Phenyl-3-(2-(2-pyridyl)ethyl)-2-thiourea
1-Phenyl-3-(2-(3-phenylthioureido)cyclohexyl)thiourea
1-Phenyl-3-(2,6-xylyl)-2-thiourea
1-Phenyl-3-(2-pyridyl)-2-thiourea
1-Phenyl-3-(2-thiazolyl)-2-thiourea(2)
1-Phenyl-3-(3-pyridyl)-2-thiourea
1-Phenyl-3-(3-pyridylmethyl)-2-thiourea
1-Phenyl-3-(4-(3-phenylthioureido)phenyl)thiourea
1-Phenyl-3-(4-trifluoromethylbenzyl)thiourea
1-Phenyl-3-(5-phenyl-1,2,4-thiadiazole-3-yl)-2-thiourea
1-Phenyl-3-(p-tolyl)-2-thiourea
1-Phenyl-3-(p-tolylsulfonyl)-2-thiourea
1-Phenyl-3-propyl-2-thiourea
1-Phenyl-3-tetradecyl-2-thiourea
1-Pyridine-3-yl-methyl-3-(2-trifluoromethylphenyl)thiourea
1-tert-Butyl-3-phenylthiourea
2-(1,1-Dioxo-2,5-dihydro-1H-thiophene-3-yl-methyl)isothiourea,hydrochloride
2-(2-Aminoethyl)isothiourea
2-(2-Cyanoethyl)isothiourea
2-(3-Carbamimidoylsulfanyl-me[thyl]-2,4,6-trime[thyl]benzyl)isothiourea
2-(3-Carbamimidoylsulfanylmethylbenzyl)isothiourea
2-(3-Carbamimidoylsulfanylmethylbenzyl)isothiourea
(2,3-Difluorophenyl)thiourea
(2,3-Dimethylphenyl)thiourea
2-(3-Phenylbutyl)isothiourea
(2,4,6-Trimethylphenyl)thiourea
2-(4-Carbamimidoylsulfanylmethylbenzyl)isothiourea
2-(4-Carbamimidoylsulfanylmethylbenzyl)isothiourea
(2,4-Difluorophenyl)thiourea
2-(4-Hydroxy-1,1-dioxotetrahydrothiophene-3-yl)isothiourea
2-(4-Me[thyl]-1,1-dioxo-4H-thiophene-3-yl)isothiourea
2-(4-Methyl-1,1-dioxo-2,3-dihydro-1H-thiophene-3-yl)isothiourea
2-(4-Methyl-1,1-dioxo-2,5-dihydro-1H-thiophene-3-yl)isothiourea
(2,5-Difluorophenyl)thiourea
2-(6-Carbamimidoylsulfanyl-me[thyl]naphthalene-2-yl-me[thyl])isothiourea
(2,6-Difluorophenyl)thiourea
2-Benzoylisothiourea
2-Benzyl-1-(3-(2-mercaptoethyl)-3H-benzothiazole-2-ylidene)isothiourea
2-Hydroxy-3-iminomethyl benzoic acid, compound with thiourea
(3,4,5-Trimethoxyphenyl)thiourea
3-(4-Chlorophenyl)-1,1-dimethyl-2-thiourea
3-(Adamantane-1-carbonyl)-1,1-diethylthiourea
3-Allyl-1-(3-chlorobenzyl)-1-methyl-2-thiourea
3-Benzoyl-1,1-diallyl-2-thiourea
3-Benzoyl-1,1-dimethylthiourea
3-Benzyl-1,1-dimethyl-2-thiourea
(3-Dimethylaminopropyl)thiourea
(3-Fluorophenyl)thiourea
[3-(Trifluoromethyl)phenyl]thiourea
(4-Ethoxyphenyl)thiourea
(4-Fluorophenyl)thiourea
Acetylthiourea
Ethylene bis(isothiourea)
N-(1,1-Dioxidotetrahydro-3-thienyl)-N′-(2-furoyl)-N-methylthiourea
N′-(1,3-Dimethyl-2,4-dioxo-1,2,3,4-tetrahydro-5-pyrimidinyl)-N,N-dimethylthiourea
N-((1,3-Dioxo-3,4-dihydro-2(1H)-naphthalenylidene)methyl)-N′-octadecylthiourea
N-(1-(4-Br[omo]phenyl)ethylidene)-N′-(4-me[thyl]-6-oxo-1,6-dihydro-2-pyrimidinyl)thiourea
N-(1-Methyl-2-phenylethyl)thiourea
N-(1-Methyl-2-propenyl)-N′-(4-morpholinyl)thiourea
N-(2-((1,1,2,2,3,3,3-Heptafluoropropyl)thio)ph[enyl])-N′-(2-thienylcarbonyl)thiourea
N-(2-((2,4-Dichlorobenzyl)sulfonyl)-2-(2,4-dichlorophenyl)vinyl)thiourea
N-(2,2-Dicyanovinyl)thiourea
N-(2,2-Dimethylpropanoyl)-N′-(2-nitrophenyl)thiourea
N-(2-(2-Oxo-1-pyrrolidinyl)ethyl)-N′-phenylthiourea
N-(2-(3,4-Dimethoxyph[enyl])et[thyl])-N′-((2,4-dioxo-2H-coumarin-3(4H)-ylidene)me[thyl])thiourea
N-(2,3-Dichlorophenyl)-N′-(2-methyl-3-furoyl)thiourea
N-(2,3-Dihydro-1,4-benzodioxin-2-yl-methyl)-N′-(4-methylbenzoyl)thiourea
N-(2,4,6-Trichlorophenyl)thiourea
N-((2,4,6-Trioxotetrahydro-5(2H)-pyrimidinylidene)methyl)thiourea
N-(2,4-Dichlorobenzoyl)-N′-(2-pyridinylmethyl)thiourea
N-(2,4-Dichlorobenzoyl)-N′-(tetrahydro-2-furanylmethyl)thiourea
N-(2,4-Dichlorophenyl)-N′-(2,2,2-trichloro-1-(formylamino)ethyl)thiourea
N-(2,4-Dichlorophenyl)-N′-(2-methylbenzoyl)thiourea
N-(2,4-Difluorophenyl)-N′-(2-methylbenzoyl)thiourea
N-(2,4-Difluorophenyl)-N′-(3-methyl-2-furoyl)thiourea
N-(2,4-Dimethylphenyl)-N′-(2-methyl-3-furoyl)thiourea
N-(2,4-Dimethylphenyl)-N′-(2-methylbenzoyl)thiourea
N-(2,4-Dimethylphenyl)-N′-(3-furoyl)thiourea
N-(2,4-Dimethylphenyl)-N′-(3-methyl-2-furoyl)thiourea
N-(2,4-Dimethylphenyl)-N′-(4-methylbenzoyl)thiourea
N-(2,4-Dimethylphenyl)thiourea
N-((2,4-Dioxo-1,2,3,4-tetrahydro-3-quinolinyl)methyl)-N′-hexylthiourea
N-(2,4-Dioxo-1,2,3,4-tetrahydro-5-pyrimidinyl)-N′-(4-methylbenzoyl)thiourea
N-((2,4-Dioxo-2H-coumarin-N-3(4H)-ylidene)methyl)-N′-octadecylthiourea
N-((2,4-Dioxo-2H-coumarin-N-3(4H)-ylidene)methyl)-N′-phenylthiourea
N-(2,5-Dichlorophenyl)-N′-(2,2,2-trichloro-1-(formylamino)ethyl)thiourea
N-(2,5-Dichlorophenyl)thiourea
N-(2,6-Dime[thyl]ph[enyl])-N′-((2,4-dioxo-1,4-dihydro-3(2H)-quinolinylidene)me[thyl])thiourea
N-(2,6-Dichlorophenyl)-N′-(3-furoyl)thiourea
N-(2,6-Dichlorophenyl)-N′-(5-methyl-2-furoyl)thiourea
N-(2-Benzoyl-3-oxo-3-phenyl-1-propenyl)-N′-(2-tert-butyl-6-ethylphenyl)thiourea
N-(2-(Benzylsulfinyl)-2-phenylvinyl)-N′-(2,4-dimethylphenyl)thiourea
N-(2-(Benzylsulfinyl)-2-phenylvinyl)-N′-(2-tert-butyl-6-ethylphenyl)thiourea
N-(2-(Benzylsulfinyl)-2-phenylvinyl)-N′-phenylthiourea
N-(2-Bromobenzoyl)-N′-(2-furylmethyl)thiourea
N-(2-Chlorobenzoyl)-N′-(5-(3-(2-furyl)acryloyl)-4-me[thyl]-1,3-thiazole-2-yl)thiourea
N-(2-Chlorophenyl)-N′-((6-me[thyl]-2,4-dioxo-2H-pyrane-3(4H)-ylidene)methyl)thiourea
N-(2-Fluorophenyl)-N′-(2-methyl-3-furoyl)thiourea
N-(2-Fluorophenyl)-N′-(3-methyl-2-furoyl)thiourea
N-(2-Fluorophenyl)-N′-(5-methyl-2-furoyl)thiourea
N-(2-Furoyl)-N′-(4-methylphenyl)thiourea
N-(2-Furoyl)-N′-(4-(trifluoromethoxy)phenyl)thiourea
N-(2-me[th]o[xy]benzylidene)-N′-(4-me[thyl]-6-oxo-1,6-dihydro-2-pyrimidinyl)thiourea
N-(2-Methyl-3-furoyl)-N′-(4-(trifluoromethyl)phenyl)thiourea
N-(2-Methylbenzoyl)-N′-(2-pyridinyl)thiourea
N-(2-Methylphenyl)-N′-(3-me[thyl]-5-thioxo-1,5-dihydro-4H-1,2,4-triazole-4-yl)thiourea
N-(3-((1,1,2,2,3,3,3-Heptafluoropropyl)thio)ph[enyl])-N′-(2-thienylcarbonyl)thiourea
N-(3,4-Dic[hloro]benzoyl)-N′-(5-(3-(2-furyl)acryloyl)-4-me[thyl]-1,3-thiazole-2-yl)thiourea
N-(3,4-Dichlorophenyl)-N′-(3-methyl-2-furoyl)thiourea
N-(3,4-Dichlorophenyl)-N′-(5-methyl-2-furoyl)thiourea
N-(3,4-Dihydro-2H-pyrrole-5-yl)-N-phenylthiourea
N-(3,4-Dimethoxybenzylidene)-N′-(4-me[thyl]-6-oxo-1,6-dihydro-2-pyrimidinyl)thiourea
N-(3,4-Dimethylphenyl)thiourea
N-(3,5-Bis(trifluoromethoxy)phenyl)-N′-(3-furoyl)thiourea
N-(3,5-Dibromo-2-pyridinyl)-N′-(2-thienylcarbonyl)thiourea
N-(3,5-Dibromo-2-pyridinyl)-N′-(4-methylbenzoyl)thiourea
N-(3-Acetamidophenyl)thiourea
N-(3-Br[omo]benzoyl)-N′-(5-(3-(3-br[omo]phenyl)acryloyl)-4-me[thyl]-1,3-thiazole-2-yl)thiourea
N-(3-Carboxyphenyl)thiourea
N-(3-((Difluoromethyl)thio)phenyl)-N′-(2-thienylcarbonyl)thiourea
N-(3-Ethoxy-4-HO[sic]-benzylidene)-N′-(4-me[thyl]-6-oxo-1,6-dihydro-2-pyrimidinyl)thiourea
N-(3-Fluorophenyl)thiourea
N-(3-Furoyl)-N′-(4-iodophenyl)thiourea
N-(3-Furoyl)-N′-(4-methoxyphenyl)thiourea
N-(3-Furoyl)-N′-(4-(trifluoromethyl)phenyl)thiourea
N-(3-Hydroxyphenyl)thiourea
N-(3-Methoxyphenyl)thiourea
N-(3-Methoxyphenyl)thiourea
N-(3-Methyl-2-butenoyl)-N′-phenylthiourea
N-(3-Methyl-2-furoyl)-N′-(3-(trifluoromethyl)phenyl)thiourea
N-(3-Methyl-2-furoyl)-N′-(4-methylphenyl)thiourea
N-(3-Methyl-2-furoyl)-N′-(4-(trifluoromethyl)phenyl)thiourea
N-((3-Methyl-5-oxo-1-phenyl-1,5-dihydro-4H-pyrazole-4-ylidene)methyl)thiourea
N-(3-Methyl-5-thioxo-1,5-dihydro-4H-1,2,4-triazole-4-yl)-N′-phenylthiourea
N-(3-Methylphenyl)-N′-(3-me[thyl]-5-thioxo-1,5-dihydro-4H-1,2,4-triazole-4-yl)thiourea
N-(3-Methylphenyl)-N′-(4-methyl-1-piperazinyl)thiourea
N-(3-(Trifluoromethyl)phenyl)-N′-(1,2,2-trimethylpropyl)thiourea
N-(4-(2-Thienyl)-1,3-thiazole-2-yl)thiourea
N-(4-((4-Fluorobenzyl)thio)phenyl)-N′-(4-methoxyphenyl)thiourea
N-(4-(4-Morpholinyl)phenyl)-N′-(2-thienylcarbonyl)thiourea
N-(4-(4-Morpholinyl)phenyl)-N′-(4-nitrobenzoyl)thiourea
N-(4-Acetamidophenyl)thiourea
N-(4-Bromobenzylidene)-N′-(6-me[thyl]-5-oxo-4,5-dihydro-1,2,4-triazine-3-yl)thiourea
N-(4-Bromophenyl)-N′-(3-furoyl)thiourea
N-(4-Carboxyphenyl)thiourea
N-(4-Chlorobenzylidene)-N′-(4-methyl-6-oxo-1,6-dihydro-2-pyrimidinyl)thiourea
N-((4-Chlorophenoxy)acetyl)-N′-(2-nitrophenyl)thiourea
N-(4-Chlorophenyl)-N′-(2,4-dichlorobenzoyl)thiourea
N-(4-Chlorophenyl)-N′-(2-furoyl)thiourea
N-(4-Chlorophenyl)-N′-(2-methyl-3-furoyl)thiourea
N-(4-Chlorophenyl)-N′-(3-methyl-2-furoyl)thiourea
N-(4-((Difluoromethyl)thio)phenyl)-N′-(2-thienylcarbonyl)thiourea
N-(4-((Difluoromethyl)thio)phenyl)-N′-(phenylacetyl)thiourea
N-(4-Ethoxyphenyl)-N′-(4-methyl-1-piperazinyl)thiourea
N-(4-Ethoxyphenyl)thiourea
N-(4-Fluorophenyl)-N′-(2-methyl-3-furoyl)thiourea
N-(4-Fluorophenyl)-N′-(3-methyl-2-furoyl)thiourea
N-(4-Fluorophenyl)-N′-(4-methylbenzoyl)thiourea
N-(4-Fluorophenyl)-N′-(5-methyl-2-furoyl)thiourea
N-(4-Fluorophenyl)-N′-(phenyl(((phenylsulfonyl)methyl)imino)methyl)thiourea
N-(4-Fluorophenyl)thiourea
N-(4-Hydroxyphenyl)thiourea
N-(4-Iodophenyl)-N′-(2-methyl-3-furoyl)thiourea
N-(4-Me[thyl]-6-oxo-1,6-dihydro-2-pyrimidinyl)-N′-(1-(4-nitroph[enyl])ethylidene)thiourea
N-(4-Methoxybenzylidene)-N′-(4-methyl-6-oxo-1,6-dihydro-2-pyrimidinyl)thiourea
N-(4-Methoxybenzylidene)-N′-(6-me[thyl]-5-oxo-4,5-dihydro-1,2,4-triazine-3-yl)thiourea
N-(4-Methoxyphenyl)-N′-(2-methyl-3-furoyl)thiourea
N-(4-Methoxyphenyl)-N′-(3-me[thyl]-5-thioxo-1,5-dihydro-4H-1,2,4-triazole-4-yl)thiourea
N-(4-Methoxyphenyl)thiourea
N-(4-Methyl-5-(3-(2-methylphenyl)acryloyl)-1,3-thiazole-2-yl)thiourea
N-(4-Methyl-5-(3-(3-nitrophenyl)acryloyl)-1,3-thiazole-2-yl)thiourea
N-(4-Methyl-6-oxo-1,6-dihydro-2-pyrimidinyl)-N′-(2-nitrobenzylidene)thiourea
N-(4-Methylbenzoyl)-N′-(4-(1-piperidinyl)phenyl)thiourea
N-(4-Methylphenyl)-N′-(phenyl(((phenylsulfonyl)methyl)imino)methyl)thiourea
N-(4-Methylphenyl)thiourea
N-(4-Nitrobenzoyl)-N′-(1,3-thiazole-2-yl)thiourea
N-(4-Nitrobenzoyl)-N′-(4-nitrophenyl)thiourea
N-(4-Sulfamoyl)phenyl)thiourea
N-(4-tert-Butylphenyl)-N′-(2-methyl-3-furoyl)thiourea
N-(4-tert-Butylphenyl)-N′-(2-methylbenzoyl)thiourea
N-(4-tert-Butylphenyl)-N′-(2-thienylcarbonyl)thiourea
N-(4-tert-Butylphenyl)-N′-(3-furoyl)thiourea
N-(4-tert-Butylphenyl)-N′-(3-methyl-2-furoyl)thiourea
N-(5-(2,4-Dichlorophenyl)-1,3,4-oxadiazole-2-yl)thiourea
N-(5-(3-(2,4-Dichlorophenyl)acryloyl)-4-methyl-1,3-thiazole-2-yl)thiourea
N-(5-(3-(2-Furyl)acryloyl)-4-methyl-1,3-thiazole-2-yl)-N′-hexanoylthiourea
N-(5-(3-(2-Furyl)acryloyl)-4-methyl-1,3-thiazole-2-yl)-N′-palmritoylthiourea
N-(5-(3-(2-Furyl)acryloyl)-4-methyl-1,3-thiazole-2-yl)-N′-propionylthiourea
N-(5-(3-(2-HO[sic]-ph[enyl])acryloyl)-4-me[thyl]-1,3-thiazole-2-yl)-N′-(4-nitrobenzoyl)thiourea
N-(5-(3-(3,4-Dimethoxyphenyl)acryloyl)-4-methyl-1,3-thiazole-2-yl)thiourea
N-(5-(3-(3-Bromophenyl)acryloyl)-4-me[thyl]-1,3-thiazole-2-yl)-N′-isobutyrylthiourea
N-(5-(3-(3-Bromophenyl)acryloyl)-4-methyl-1,3-thiazole-2-yl)-N′-propionylthiourea
N-(5-(3-(4-Chlorophenyl)acryloyl)-4-methyl-1,3-thiazole-2-yl)thiourea
N-(5-(3-(4-Methoxyphenyl)acryloyl)-4-methyl-1,3-thiazole-2-yl)thiourea
N-(5-(4-Methylphenyl)-1,3,4-oxadiazole-2-yl)thiourea
N-(5-Bromo-2-methoxybenzyl)-N-(4-isopropylphenyl)-N′-phenylthiourea
N-(5-Methyl-2-furoyl)-N′-(2-(trifluoromethyl)phenyl)thiourea
N-(5-(Phenoxymethyl)-1,3,4-oxadiazole-2-yl)thiourea
N-(6-(1,3-Dioxo-1,3-dihydro-2H-isoindole-2-yl)hexanoyl)-N′-(2-me[th]o[xy]phenyl)thiourea
N-((6-Methyl-2,4-dioxo-2H-pyrane-3(4H)-ylidene) methyl)-N′-octadecylthiourea
N-((6-Methyl-2,4-dioxo-2H-pyrane-3(4H)-ylidene)methyl)-N′-phenylthiourea
N-((6-Methyl-2,4-dioxo-2H-pyrane-3(4H)-ylidene)methyl)thiourea
N-(9-Anthrylmethyl)-N′-benzoyl-N-methylthiourea
N-Allyl-N′-((2,4-dioxo-1,2,3,4-tetrahydro-3-quinolinyl)methyl)thiourea
N-Allyl-N′-((2,4-dioxo-2H-coumarin-N-3(4H)-ylidene)methyl)thiourea
N-Allyl-N′-(4-methyl-1-piperazinyl)thiourea
N-Allylthiourea(2)
N-Benzoyl-N′-(1-naphthyl)thiourea
N-Benzoyl-N′-(2-nitrophenyl)thiourea
N-Benzoyl-N′-(3-methylphenyl)thiourea
N-Benzoyl-N′-(3-pyridinyl)thiourea
N-benzoyl-N′-(4-chlorophenyl)thiourea
N-Benzoyl-N′-(4-methyl-6-oxo-1,6-dihydro-2-pyrimidinyl)thiourea
N′-Benzoyl-N,N-diethylthiourea
N′-Benzoyl-N,N-dihexylthiourea
N′-Benzoyl-N,N-diisobutylthiourea
N-Benzyl-N′-((1,3-dioxo-1,3-dihydro-2H-indene-2-ylidene)methyl)thiourea
N-Benzyl-N′-(1,3-thiazole-2-yl)thiourea
N-Benzyl-N′-(2-pyridinyl)thiourea
N-Benzyl-N′-(3-(4-br[omo]ph[enyl])-5-thioxo-1,5-dihydro-4H-1,2,4-triazole-4-yl)thiourea
N-Benzyl-N′-(phenyl(phenylimino)methyl)thiourea
N-Boc-thiourea
N-Butyl-N′-((2,4-dioxo-1,4-dihydro-3(2H)-quinolinylidene)methyl)thiourea
N-Cyclohexyl-N′-(1-phenylethyl)thiourea
N′-Cyclohexyl-N,N-diisobutylthiourea
N-Dansyl-N′-ethylthiourea
N-Decyl-N′-(2-hydroxyethyl)thiourea
N-Ethyl-N′-(3-methyl-2-butenoyl)-N-phenylthiourea
N-Ethylthiourea (2)
N-Hexanoyl-N′-(3-pyridinylmethyl)thiourea
N-Methallyl-N′-methylthiourea
N-Methylthiourea (2)
N,N-Bis(2-cyanoethyl)-N′-hexylthiourea
N,N′-Bis(4-ethoxyphenyl)thiourea
N,N′-Di-boc-S-methylisothiourea
N,N′-Di-(tert-butoxycarbonyl)thiourea
N,N′-Dibutylthiourea(2)
N,N′-Diethylthiourea
N,N′-Dimethylthiourea
N,N′-Diphenylthiourea
N,N′-Diphenylthiourea
N′-Octadecylfluorescein-5-thiourea
N-Phenyl-N′-(phenyl(phenylimino)methyl)thiourea
N-Phenyl-N′-(tetrahydro-2-furanylmethyl)thiourea
N-Phenylthiourea
N-Phenylthiourea
N-(tert-Butyl)-N′-(3-(trifluoromethyl)phenyl)thiourea
(Phenylphenyliminomethyl)thiourea
Propylthiourea
S-[(2-Guanidino-4-thiazoyl)methyl]isothiourea
S-Benzylisothiourea
S-Ethylisothiourea
S-Isopropylisothiourea
S-Methyl-N-(4-toluenesulfonyl)isothiourea
S-Methylisothiourea
Tetramethylthiourea
Thiourea
Toluene-4-sulfonic acid, 2-(2-(1-oxypyridine-2-yl)ethyl)isothiourea
1,3-Bis-(benzyloxycarbonyl)-2-methyl-2-thiopseudourea
1,3-Bis-(tert-butoxycarbonyl)-2-methyl-2-thiopseudourea
2-Benzyl-2-thiopseudourea
2-Ethyl-2-thiopseudourea
2-Imidazolidinethione
2-Imino-4-thiobiuret
(Amidinothio)acetic acid
Formamidine sulfinic acid
S-(2-Aminoethyl)isothiouronium bromide

Primarily considered as copper compounds are salts and complexes of copper such as copper benzoate, copper di(methacrylate), copper acetylacetonate, or copper naphthenate, for example.

As monomers without an acid function, in addition to the vinyl and vinylcyclopropane monomers primarily acrylates and methacrylates are considered.

Monofunctional or crosslinking¹ (meth)acrylates may be monofunctional or polyfunctional (meth)acrylates which may be used individually or in mixtures. Examples of these compounds include methyl methacrylate, isobutyl methacrylate, cyclohexyl methacrylate, triethylene glycol dimethacrylate, diethylene glycol dimethacrylate, tetraethylene glycol dimethacrylate, ethylene glycol dimethacrylate, polyethylene glycol dimethacrylate, butanediol dimethacrylate, hexanediol dimethacrylate, decanediol dimethacrylate, dodecanediol dimethacrylate, bisphenol-A-dimethacrylate, trimethylolpropane trimethacrylate, ethoxylated bisphenol-A-dimethacrylate, but also bis-GMA (2,2-bis-4-(3-methacryloxy-2-hydroxypropyl)phenylpropane) and the reaction products of isocyanates, in particular di- and/or triisocyanates and methacrylates containing OH groups, and the corresponding acrylates of all the above compounds. Examples of reaction products of isocyanates are the reaction products of 1 mol hexamethylene diisocyanate with 2 mol 2-hydroxyethyl methacrylate, of 1 mol (tri(6-isocyanatohexyl)biuret with 3 mol hydroxyethyl methacrylate, and of 1 mol trimethylhexamethylene diisocyanate with 2 mol hydroxyethyl methacrylate, which are also referred to as urethane dimethacrylates. Suitable monomers in each case are the monomers themselves, prepolymers prepared from same, and mixtures thereof.
Crosslinking meth/acrylates by their nature are compounds containing 2 or more methacrylate groups in the monomer.

Examples of preferred crosslinker monomers are 2,2-bis-4-(3-methacryloxy-2-hydroxypropyl)phenylpropane) (bis-GMA), i.e., the reaction product of glycidyl methacrylate and bisphenol-A (containing OH groups), and 7,7,9-trimethyl-4,13-dioxo-3,14-dioxa-5,12-diazahexadecane-1,16-diyl-dimethacrylate (UDMA), i.e., the urethane dimethacrylate resulting from 2 mol 2-hydroxyethyl methacrylate (HEMA) and 1 mol 2-2,4-trimethylhexamethylene diisocyanate (containing urethane groups). Also preferred as crosslinker monomers are reaction products of glycidyl methacrylate with other bisphenols such as bisphenol-B (2,2′-bis-(4-hydroxyphenyl)butane), bisphenol-F (2,2′-methylenediphenol), or 4,4′-dihydroxydiphenyl, for example, and reaction products of 2 mol HEMA or 2-hydroxypropyl(meth)acrylate with in particular 1 mol of known diisocyanates such as hexamethylene diisocyanate, m-xylylene diisocyanate, or toluylene diisocyanate, for example.

Test Descriptions/Examples:

The two components, referred to below as base and catalyst component (B and C, respectively), were prepared according to a general production specification. For this purpose, the monomers were first blended into a homogeneous mixture. The initiator components were then added, and were dissolved by intensive stirring with a magnetic stirrer.

The special properties of the two-component initiator system according to the invention were investigated in greater detail for the following compositions. The components B1 in combination with C1 and C2 represent the reference system.

Base components

| | | |
|---|---|---|
| B1 | Bis-GMA | 20.580 |
| | TEGDMA | 8.820 |
| | DBPO | 0.600 |
| B2 | Bis-GMA | 20.790 |
| | TEGDMA | 8.910 |
| | CHP | 0.300 |
| B9 | Bis-GMA | 20.37 |
| | TEGDMA | 8.73 |
| | CHP | 0.900 |
| B10 | Bis-GMA | 19.347 |
| | TEGDMA | 8.291 |
| | Acrylic acid | 1.455 |
| | CHP | 0.907 |
| B122 | Bis-GMA | 17.64 |
| | TEGDMA | 7.56 |
| | CHP | 0.300 (1.00%) |
| | 4-Meta | 4.500 (15.00%) |
| B123 | Bis-GMA | 20.37 |
| | TEGDMA | 8.73 |
| | CHP | 0.300 (1.00%) |
| | Phosphoric acid ester | 0.600 (2.00%) |
| B124 | Bis-GMA | 19.74 |
| | TEGDMA | 8.46 |
| | CHP | 0.300 (1.00%) |
| | Phosphoric acid ester | 1.500 (5.00%) |

Catalyst components

| | | |
|---|---|---|
| C1 | Bis-GMA | 20.895 |
| | TEGDMA | 8.955 |
| | DMPT | 0.150 |
| C2 | Bis-GMA | 20.895 |
| | TEGDMA | 8.955 |
| | DHEPT | 0.150 |
| C3 | Bis-GMA | 20.790 |
| | TEGDMA | 8.910 |
| | ATH | 0.300 |
| C3.1 | Bis-GMA | 20.51 |
| | TEGDMA | 8.79 |
| | ATH | 0.900 |
| C3.4 | Bis-GMA | 20.769 |
| | TEGDMA | 8.901 |
| | ATH | 0.300 |
| | Cu(acac)₂ | 0.030 |
| C3.5 | Bis-GMA | 20.348 |
| | TEGDMA | 8.721 |
| | ATH | 0.901 |
| | Cu(acac)₂ | 0.029 |
| C15 | Bis-GMA | 20.348 |
| | TEGDMA | 8.721 |
| | ATH | 0.901 |
| | Copper (II) naphthenate | 0.029 |
| C121 | Bis-GMA | 20.782 |
| | TEGDMA | 8.906 |
| | ATH | 0.300 (1.00%) |
| | Cu(ac)₂ | 0.012 (0.04%) |
| C122 | Bis-GMA | 17.632 |
| | TEGDMA | 7.556 |
| | 4-Meta | 4.5 (15.00%) |
| | ATH | 0.300 (1.00%) |
| | Cu(ac)2 | 0.012 (0.04%) |
| C123 | Bis-GMA | 20.362 |
| | TEGDMA | 8.726 |
| | Sipomer PAM100 | 0.6 (2.00%) |
| | ATH | 0.300 (1.00%) |
| | Cu(ac)₂ | 0.012 (0.04%) |
| C124 | Bis-GMA | 19.732 |
| | TEGDMA | 8.456 |
| | Sipomer PAM100 | 1.5 (5.00%) |
| | ATH | 0.300 (1.00%) |
| | Cu(ac)₂ | 0.012 (0.04%) |

By introducing conventional fillers into the activated monomer resin mixtures, one skilled in the art may produce composites for various dental applications.

Suitable in particular as fillers are quartz powder and glass ceramic powder, aluminum oxides, and/or silicon oxides. Examples of particularly preferred fillers are glass powders such as barium glass, barium silicate glass, lithium, or aluminum silicate glass powders, and fine-particle silicic acids such as pyrogenic or precipitated silicic acids.

Testing of Gel Times

To determine processing times, both components were intensively mixed in a 1:1 ratio. The time required for the gel point to appear is referred to as the gel time, which may be observed for adjusting the maximum processing time. However, sensory perception is subject to individual fluctuation ranges which also depend on the curing characteristics of the system.

As an additional method for determining the initiation characteristics, the heat of reaction was calorimetrically recorded. The initial temperature increase was specified as the relevant measurement point.

The measurements showed a reliably adjustable processing time as a function of the copper content in the preparations. The variation range of the activity of the initiator system extends from extremely short inhibition times of <10 s for higher copper content (approximately 0.1%) to very long inhibition times, or even results in failure of polymerization in the absence of the copper compound.

Testing of Storage Stability

The individual components were placed in long-term storage at a temperature of 50° C. The change in processing times was documented over a maximum period of 5 months. The samples were tested using the second component, which likewise was stored at 50° C. or at room temperature (RT).

Whereas the base component of the conventional dibenzoyl peroxide-amine initiator system had spontaneously cured after 10 days, the components of the system according to the invention were still usable after 5 months. The curing was also reliably carried out in the presence of adhesive monomers under acidic conditions. The strong catalytic effect of the copper content on the activity of the initiator system was very evident in the tests. As a function of the proportion of a soluble copper compound, it was possible to demonstrably adjust much shorter processing times or to reduce the concentration of the redox partners. Both possibilities are particularly advantageous for use in dental materials, or synthetic materials for medical use, which require very brief processing times and the least possible toxicological potential.

Reference system: dibenzoyl peroxide-amine
Reference - Storage of the peroxide component at 50° C.

| | | | |
|---|---|---|---|
| B1 | 1% DBPO | 0 days | 50 s |
| | | 5 days | 40 s |
| | | 10 days | polymerized |

Reference - Storage of the amine component at 50° C.

| | | | B1 |
|---|---|---|---|
| | | | 1% DBPO |
| C1 | 0.5% DMPT | 0 months | 50 s |
| | | 3 months | 95 s |
| | | 5 months | — |
| C2 | 0.5% DHEPT | 0 months | 380 s |
| | | 3 months | — |
| | | 5 months | 420 s |

System: cumene hydroperoxide-acetylthiourea derivative
Storage of both components at 50° C.

| | | | C3 | C3.1 |
|---|---|---|---|---|
| | | | 1% ATH | 3% ATH |
| B9 | 3% CHP | 0 months | 480 s | 280 s |
| | | 3 months | 390 s | 120 s |
| | | 5 months | 200 s | |
| B10 | 3% CHP | 0 months | 210 s | 95 s |
| | 5% acrylic acid | 5 months | 225 s | 230 s |

Storage of both components at 50° C., with addition of copper

| | | | B2 |
|---|---|---|---|
| | | | 1% CHP |
| C121 | 1% ATH | 0 months | 45 s |
| | 0.04% Cu(acac)₂ | 1 month | — |
| | | 3 months | 235 s |
| C3.5 | 1% ATH | 0 months | 35 s |
| | 0.1% Cu(acac)₂ | 1 month | 70 s |
| | | 3 months | 345 s |
| C3.4 | 3% ATH | 0 months | 40 s |
| | 0.1% Cu(acac)₂ | 1 month | 80 s |
| | | 3 months | 200 s |

Storage of ATH components at 50° C., with adhesive monomer
and addition of copper

| | | | B2 |
|---|---|---|---|
| | | | 1% CHP |
| C121 | 1% ATH, 0.04% | 0 months | 45 s |
| | Cu(acac)₂ | 3 months | 85 s |
| C122 | 1% ATH, 0.04% | 0 months | 110 s |
| | Cu(acac)₂ | 3 months | 160 s |
| | 15% 4-META | | |
| C123 | 1% ATH, 0.04% | 0 months | 50 s |
| | Cu(acac)₂ | 3 months | 70 s |
| | 2% phosphoric acid ester | | |
| C124 | 1% ATH, 0.04% | 0 months | 50 s |
| | Cu(acac)₂ | 3 months | 70 s |
| | 5% phosphoric acid ester | | |

Dependence of the inhibition time on copper content
Adjustment of the processing time to the copper content

| | | | B2 |
|---|---|---|---|
| | | | 1% CHP |
| C3 | 1% ATH | 0.00% Cu(acac)₂ | No polymerization |
| | | 0.01% Cu(acac)₂ | 135 s |
| | | 0.02% Cu(acac)₂ | 75 s |
| C121 | | 0.04% Cu(acac)₂ | 45 s |
| | | 0.06% Cu(acac)₂ | 40 s |
| C3.5 | | 0.10% Cu(acac)₂ | 35 s |

[image] Effectiveness of various copper salts

| | | | B2 |
|---|---|---|---|
| | | | 1% CHP |
| C3.5 | 1% ATH | 0.10% copper (II) | 35 s |
| | | acetonylacetonate | |
| C15 | | 0.10% copper (II) naphthenate | 55 s |

Coloration of polymers as a function of the copper content

The color of polymerized (meth)acrylates is affected by the content of copper ions, which by their nature are colored. The relationship between the intrinsic coloration of the polymer and the proportion of the copper compound was determined by color measurements on test specimens. Color stability was of particular importance.

For the determination, test specimens 1 mm in thickness were produced, and after 48-hour storage were measured. The CIELab values of the transparent polymer layers in front of a white background were recorded. The color stability was monitored after 7 days at a temperature of 40° C. No change in color of the layers was observed.

Even after longer storage there was no detectable change in color. Therefore, the initiator system according to the invention together with a copper compound also completely meets the esthetic demands placed on a dental material.

[image]

1. Two-component initiator system having accelerators for curing polymerizable materials, comprising:
(a) a hydroperoxide compound containing one or more hydroperoxide groups that are bound to a tertiary carbon;
(b) a thiourea derivative;
(c) as accelerator, a copper compound which is soluble in the preparation.

2. Dental composition containing:
(a) at least one polymerizable monomer without an acid function, the polymerizable group containing a structural unit of the acrylates, methacrylates, a vinyl group, or a vinylcyclopropane;
(b) a hydroperoxide compound containing one or more hydroperoxide groups that are bound to a tertiary carbon;
(c) a thiourea derivative;
(d) a copper compound which is soluble in the preparation;
(e) optionally, one or more adhesive monomers which contain at least one acid function, selected from the group consisting of carboxylic acids, acid anhydrides, sulfonic acids, sulfinic acids, phosphoric acid esters, phosphonic acid esters, phosphonates, and phosphinates;
(f) at least one stabilizer;
(g) optionally, a photoinitiator, a finely divided filler, a solvent, or combinations thereof.

3. Dental composition according to claim 2, containing said copper compound in a proportion of at least 0.0001% by weight but no greater than 5% by weight.

4. Dental composition according to claim 3, containing said copper compound in a proportion of at least 0.01% by weight but no greater than 5% by weight.

5. Dental composition according to claim 2, containing an acid compound in a proportion of at least 0.1%.

6. Dental composition according to claim 5, containing said acid compound in a proportion of at least 1%.

7. Dental composition according to claim 6, containing said acid compound in a proportion of at least 10% by weight.

8. Dental composition according to claim 2, divided into two components, one component of the two-component system containing the hydroperoxide and the second component containing the thiourea derivative and at least one copper compound.

9. Dental composition according to claim 8, wherein the two-component system represents a combination of preparations of different and identical consistencies selected from the group consisting of the following compositions: liquid/liquid, paste/paste, paste/liquid, and powder/liquid.

10. Dental composition according to claim 8, wherein the two-component preparation is a filling material, a cement, a fissure sealant, a prosthetic material, or an adhesive.

11. Dental composition according to claim 8, wherein the two-component system is composed of a first paste having the composition (a), (b), (e), (f) and a finely divided filler, and a second paste composed of (a), (c), (d), (e), (f) and a finely divided filler.

12. Dental composition according to claim 8, wherein the two-component system in at least one component contains a photoinitiator as constituent (g), and after mixing forms a dual-curing system.

13. A filling material, cement, prosthetic material, fissure sealant, or self-adhesive composite comprising the dental composition of claim 2.

14. Dental composition according to claim 8, wherein the two-component system is composed of a first liquid having the composition (a), (b), (e), (f) and at least one volatile solvent, and a second liquid composed of (a), (c), (d), (e), (f) and at least one solvent.

15. Dental composition according to claim 8, wherein each of the two components is provided in a syringe as packaging.

16. Dental composition according to claim 8, wherein both components are provided in a double-chamber syringe as packaging.

17. Dental composition according to claim 16, wherein the components of the double-chamber syringe when discharged optionally are homogeneously mixed by a static mixer placed thereon.

18. Dental composition according to claim 8, wherein each of the two components is provided in a bottle as packaging.

19. Dental composition according to claim 8, wherein each of the two components is provided in a different kind of packaging.

20. Dental composition according to claim 9, wherein both components are separately present in a double-chamber dispenser as packaging, and are mixed during discharge.

21. Dental composition according to claim 2, wherein the material is provided in the form of a powder and a liquid, and the powder contains the constituents (c), (d), whereas the liquid contains the constituents (a), (b), (f), and optionally (e).

22. Dental composition according to claim 11, containing a filler composed of inorganic oxides, nitrides, or salts of metal, or silicate glass, aluminosilicate glass, aluminoborosilicate glass, fluoroaluminosilicate glass, quartz, colloidal silicon dioxide, pyrogenic silicon dioxide, precipitated silicon dioxide, polymeric silicon dioxide, zirconium oxide-silicon dioxide, polymeric fillers, polymerized composite fillers containing inorganic particles, and combinations thereof.

23. Dental composition according to claim 22, wherein said fillers are oxides, nitrides, or salts of metal, or silicate glass, aluminosilicate glass, aluminoborosilicate glass, and fluoroaluminosilicate glass of at least one element selected from the group consisting of Sr, Y, Zr, Ba, La, Hf, Zn, Bi, W, the lanthanides, or combinations thereof.

24. Dental composition according to claim 2, comprising water, methanol, ethanol, propanol, isopropanol, acetone, methyl ethyl ketone, ethylene glycol, glycerin, and combinations thereof as solvent.

25. Dental composition according to claim 2, containing an acidic, polymerizable compound having at least one ethylenically unsaturated group selected from the group consisting of acrylates, methacrylates, or vinyl compounds.

26. Dental composition according to claim 25, containing acid monomers having at least one of the acid functions from the compounds of phosphoric acid esters, phosphonic acid, phosphinic acid, sulfuric acid esters, sulfonic acid, sulfinic acid, boric acid esters, boric acid, or carboxylic acid.

27. Dental composition according to claim 2, containing at least one hydroperoxide compound selected from the group consisting of t-butylhydroperoxide, t-amylhydroperoxide, isopropylbenzene hydroperoxide, p-diisopropylbenzene hydroperoxide, 5-phenyl-4-pentenylhydroperoxide, pinane hydroperoxide, 1,1,3,3-tetramethylbutylhydroperoxide, and combinations thereof.

28. A restorative, orthodontic, or endodontic composition, comprising the dental composition of claim 2, divided into two components.

29. Dental composition according to claim 2, which allows a curing time of less than 15 minutes after mixing.

30. Dental composition according to claim 29 which allows a curing time of less than 5 minutes after mixing.

31. Dental composition according to claim 29 which allows a curing time of less than 15 minutes after mixing, after both components have been stored for at least two months at 50° C.

32. Dental composition according to claim 29 which allows a curing time of less than 15 minutes after mixing, after both components have been stored for at least three months at 37° C.

33. Two-component initiator system according to claim 1 which is free of amine.

34. Dental composition according to claim 14, wherein each of the two components is provided in a syringe as packaging.

35. Dental composition according to claim 14, wherein both components are provided in a double-chamber syringe as packaging.

36. Dental composition according to claim 35, wherein the components of the double-chamber syringe when discharged optionally are homogeneously mixed by a static mixer placed thereon.

36. Dental composition according to claim 21, containing a filler composed of inorganic oxides, nitrides, or salts of metal, or silicate glass, aluminosilicate glass, aluminoborosilicate glass, fluoroaluminosilicate glass, quartz, colloidal silicon dioxide, pyrogenic silicon dioxide, precipitated silicon dioxide, polymeric silicon dioxide, zirconium oxide-silicon dioxide, polymeric fillers, polymerized composite fillers containing inorganic particles, and combinations thereof.

37. Dental composition according to claim 36, wherein said fillers are oxides, nitrides, or salts of metal, or silicate glass, aluminosilicate glass, aluminoborosilicate glass, and fluoroaluminosilicate glass of at least one element selected from the group consisting of Sr, Y, Zr, Ba, La, Hf, Zn, Bi, W, the lanthanides, or combinations thereof.
